(19) United States
(12) Patent Application Publication
(10) Pub. No.: US 2025/0076903 A1
(43) Pub. Date: Mar. 6, 2025

(54) Zero Emission Displacer-Based Liquid Level Control

(71) Applicant: Devon Energy Corporation, Oklahoma City, OK (US)

(72) Inventor: John Paul Jackson, Yoakum, TX (US)

(73) Assignee: Devon Energy Corporation, Oklahoma City, OK (US)

(21) Appl. No.: 18/822,189

(22) Filed: Aug. 31, 2024

Related U.S. Application Data
(60) Provisional application No. 63/536,046, filed on Aug. 31, 2023.

(51) Int. Cl. G05D 9/12; G01F 23/32

(52) U.S. Cl. CPC G05D 9/12; G01F 23/32

(57) ABSTRACT

A dump valve system includes an automatic dump valve connected downstream from the liquid discharge and configured to adjust the flow rate of the liquid through the liquid discharge, a float assembly, a level controller and a control module. The float assembly includes a float inside the vessel and a float arm connected to the float. The level controller includes a linear position sensor assembly configured to output an electric signal and an internal drive mechanism between the float arm and the linear position sensor assembly, where the internal drive mechanism translates a rotational movement of the float arm into a linear movement of the linear position sensor assembly. The control module is configured to adjust the operation of the automatic dump valve based on the output from the linear position sensor assembly.

### RELATED APPLICATIONS

This application claims the benefit of U.S. Provisional Patent Application Ser. No. 63/536,046 filed Aug. 31, 2023 entitled, “Zero Emission Displacer-Based Liquid Level Control,” the disclosure of which is herein incorporated by reference.

### FIELD OF THE INVENTION

This invention relates generally to the field of dump valves, and more specifically, to a dump valve with an optimized control system.

### BACKGROUND OF THE INVENTION

Separator vessels are typically large, pressurized weirs that separate oil, water and gas produced from a well based on the relative densities of those fluids. The separator vessel is designed to dump the separated fluids at a rate that approximates the input rate to the separator from the well, while holding the fluids in the vessel for a residence time and pressure that encourages good separation of the gases, crude oil and water-based fluids. If the vessel discharges the fluids too rapidly, gases may become entrained in the crude oil discharge line, which can impair the function of flow meters located downstream from the separator vessel. If the vessel discharges the fluids too slowly, fluids may accumulate in the separator and lead to an emergency shut down (ESD) event.

In the past, mechanical, electrical or pneumatic dump valves have been used to control the flow of crude oil through the discharge line from the separator vessel. In some applications, a separate dump valve is also used to control the flow of water-based fluids from the vessel. In each case, a float or indicator is often used to determine the interface between the heavier water-based fluids and the lighter crude oil, or between the crude oil and gases inside the separator. As the float moves up and down inside the separator, the dump valve is opened and closed to permit or prohibit the discharge of crude oil or water from the separator.

Basic dump valves are mechanically operated and employ a linkage between the float arm and the dump valve. Although widely adopted, the use of conventional mechanical dump valves may be insufficient for volatile wells, particularly with the increased demands on the corresponding metering system directly downstream from the vessel.

Electronic and pneumatic valves have been used as an alternative to conventional mechanical dump valves, but remain insufficient for certain applications. In particular, modern pneumatic and electric dump valves tend to be installed with a simple single point level controller that limits valve stroke that results in a relatively fixed dump rate. For example, if the operator sets the stroke on the valve to provide an estimated flowrate of about 1,000 barrels/day at 50 psig operating pressure and the well temporarily increases production to a rate of 3,000 barrels/day for 30 minutes, the limited stroke range of the dump valve will not open enough to discharge the incoming fluid, which will result in an increased level inside the separator and an emergency shut down (ESD) event. In this way, existing level controllers and dump valves are limited by vessel level monitoring as well as a restricted and narrowly defined dump rate.

Accordingly, there is a need for an improved vessel level and dump valve control system that permits a wider range of dump rates as well as monitors the level in the vessel more than a single, static level point. It is to this and other deficiencies in the prior art that the present invention is directed.

### SUMMARY OF THE INVENTION

In some embodiments, the present disclosure is directed to a dump valve system for controlling the level of a liquid inside a vessel that includes a liquid discharge. The dump valve system includes an automatic dump valve connected downstream from the liquid discharge and configured to adjust the flow rate of the liquid through the liquid discharge, a float assembly, a level controller and a control module. The float assembly includes a float inside the vessel and a float arm connected to the float. The level controller includes a linear position sensor assembly configured to output an electric signal and an internal drive mechanism between the float arm and the linear position sensor assembly, where the internal drive mechanism translates a rotational movement of the float arm into a linear movement of the linear position sensor assembly. The control module is configured to adjust the operation of the automatic dump valve based on the output from the linear position sensor assembly.

In other embodiments, the present disclosure is directed to a dump valve system for controlling the level of a liquid inside a vessel that includes a liquid discharge, where the dump valve system includes an automatic dump valve connected downstream from the liquid discharge and configured to adjust the flow rate of the liquid through the liquid discharge, a float assembly, a level controller, a flow meter and a control module. In these embodiments, the float assembly includes a float inside the vessel and a float arm connected to the float. The level controller includes a linear position sensor assembly configured to output an electric signal and an internal drive mechanism between the float arm and the linear position sensor assembly, where the internal drive mechanism translates a rotational movement of the float arm into a linear movement of the linear position sensor assembly. The flow meter is configured to measure the flow rate of liquids discharged from the automatic dump valve and output a signal representative of the measured flow rate. The control module the control module is configured to adjust the automatic dump valve to change a dump rate of fluids passing through the automatic dump valve based on the output from the linear position sensor assembly and the output from the flow meter.

In yet other embodiments, the present disclosure is directed to a dump valve system for controlling the level of a liquid inside a vessel that includes a liquid discharge, where the dump valve system includes an automatic dump valve connected downstream from the liquid discharge and configured to adjust the flow rate of the liquid through the liquid discharge, float assembly, and a level controller. The float assembly includes a float inside the vessel and a float arm connected to the float. The level controller includes a housing, a primary shaft inside the housing, and an internal drive mechanism. The float arm is coupled to the primary shaft such that float arm pivots about the primary shaft, and a linear position sensor assembly configured to output an electric signal. The linear position sensor assembly includes a body and a plunger that extends from and retracts into the body. The internal drive mechanism between the float arm and the linear position sensor assembly translates a rotational movement of the float arm into a linear movement of the linear position sensor assembly. The internal drive mechanism includes a reaction linkage connected to and rotatable with the primary shaft, a torque bar pivotable about the primary shaft, a flapper bar in contact with the plunger of the linear position sensor assembly, and a sensitivity fulcrum positioned between the flapper bar and the torque bar.

### BRIEF DESCRIPTION OF DRAWINGS

FIG. 1 is a cross-sectional depiction of a separator vessel with a dump valve system coupled to an electric level controller.

FIG. 2 is a close-up internal view of the electric level controller of FIG. 1.

FIGS. 3A and 3B are side views of the liner position sensor of the level controller of FIG. 2 in extended and retracted states.

FIG. 4 is a cross-sectional depiction of a separator vessel with a dump valve system coupled to a dual electric-pneumatic level controller.

FIG. 5 is a close-up internal view of the dual electric-pneumatic level controller in FIG. 4.

FIG. 6 is a cross-sectional depiction of a separator vessel with a dump valve system coupled to an integrated, internal level controller.

FIG. 7 is a close-up internal view of the integrated level controller in FIG. 6.

### DETAILED DESCRIPTION

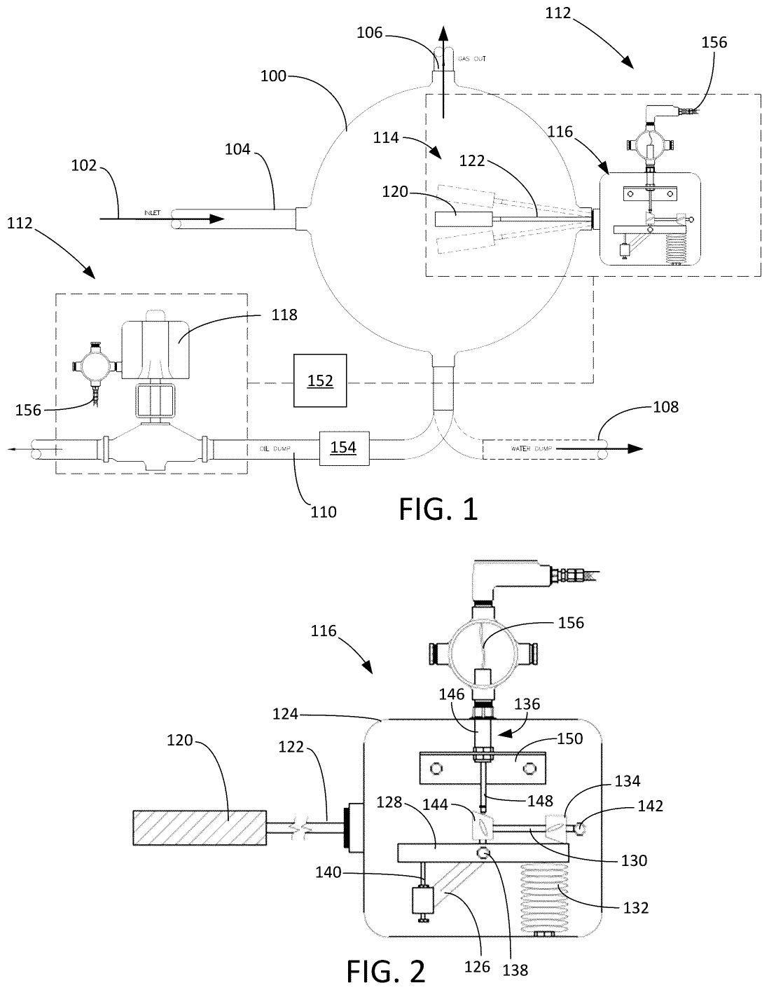

Turning first to FIG. 1, shown therein is a vessel 100 that is a three phase separator configured to separate a multiphase feed stream 102 from an oil or gas well (not shown). The vessel 100 includes an inlet 104, a gas discharge 106, a water discharge 108 and an oil discharge 110. In accordance with well-established petroleum fluid separation mechanics, the multiphase feed stream 102 is injected into the separator 100 under pressure, where the constituent components separate according to their relative densities. The gas is discharged through the gas discharge 106, the water (which may include other fluids) is discharged from the water discharge 108, and the liquid petroleum products (e.g., crude oil) are discharged through the oil discharge 110.

A dump valve system 112 is used to control the level of the liquid petroleum products in the vessel 100. The dump valve system 112 includes a float (displacer) assembly 114, a level controller 116 and an automatic dump valve 118. The float assembly 114 includes a float (or displacer) 120 that is positioned inside the vessel 100 and configured to rise or fall with a change in the level of fluids inside the vessel 100. The float 120 can be configured, for example, with a buoyancy or weight that allows the float 120 to remain positioned at the oil-water interface in the vessel 100. The float assembly 114 also includes a float arm 122 that is connected between the float 120 and the level controller 116. The float arm 122 can be a single arm or a collection of interconnected linkages that transfer the substantially vertical movement of the float 120 in the vessel 100 into a rotational movement in the level controller 116. The level controller 116 includes an internal drive mechanism that converts the rotational movement of the float arm 122 into an electric signal, which is used to drive the operation of the automatic dump valve 118.

Turning to FIG. 2, shown therein is a close-up view of a first embodiment of the level controller 116. The level controller 116 includes a housing 124, a reaction linkage 126, a torque bar 128, a flapper bar 130, a balance spring 132, a sensitivity fulcrum 134 and a linear position sensor assembly 136. The movement of the float arm 122 is passed to the reaction linkage 126 through a primary shaft 138. The reaction linkage 126 can include an adjustment screw 140 that contacts the torque bar 130. The collection of the reaction linkage 126, torque bar 128, flapper bar 130, balance spring 132, and sensitivity fulcrum 134 are part of the “internal drive mechanism” within the level controller 116. In other embodiments, the internal drive mechanism will include additional or alternative components.

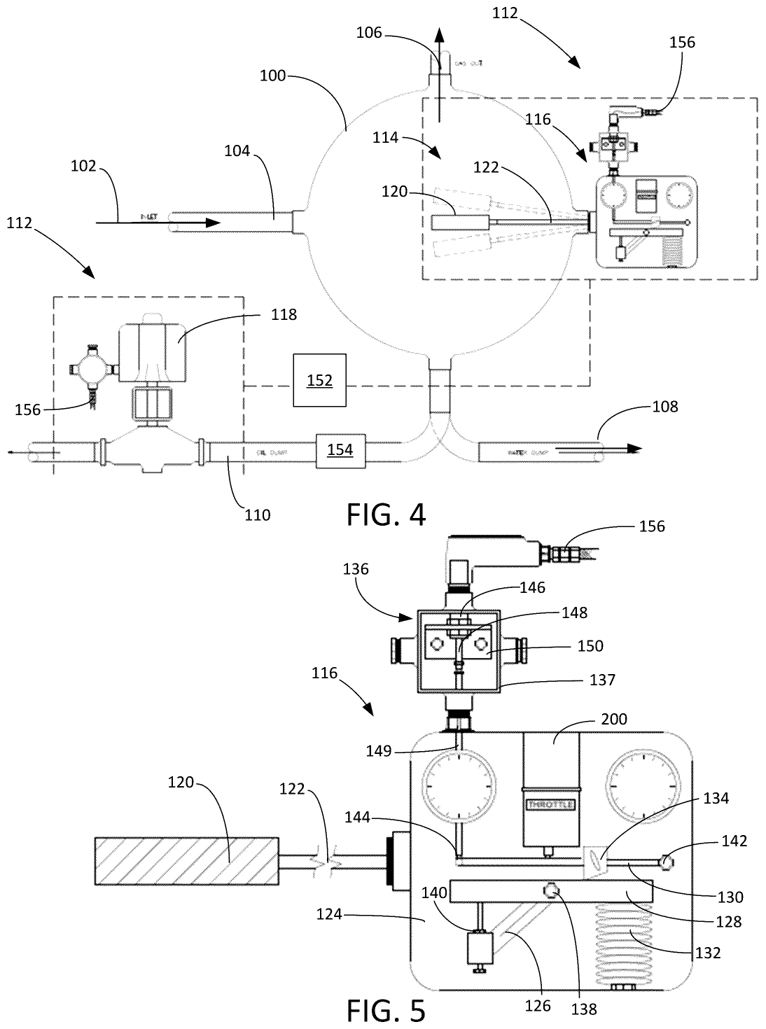

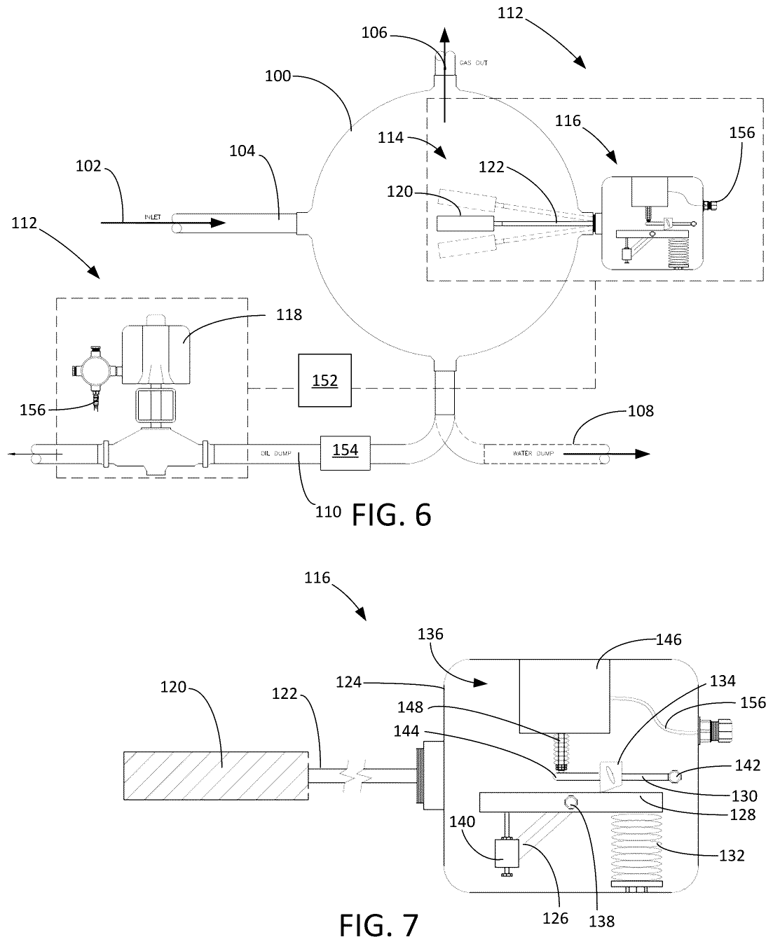

In the embodiment depicted in FIG. 2, the level controller 116 is a “Norriseal Level Controller” available from Alberta Oil Tool that has been adapted for use with linear position sensor assembly 136. In the embodiment depicted in FIG. 2, the pneumatic throttle 200 that is typically found in the Norriseal Level Controller has been replaced by the linear position sensor assembly 136 so that the output of the level controller 116 is electrical rather than pneumatic. In this way, the level controller 116 in FIG. 2 can be a conventional Norriseal Level Controller that has been retrofitted with the linear position sensor assembly 136. In the embodiment depicted in FIGS. 4 and 5, the linear position sensor assembly 136 has been added in an external housing 137 attached to the level controller 116 without removing the pneumatic throttle 200. In this way, the level controller 116 depicted in FIGS. 4 and 5 is a dual output embodiment in which both pneumatic and electrical signals are generated by the level controller 116.

In both embodiments, the internal drive mechanism is substantially the same. As the float 120 rises in the vessel 100 and the float arm 122 rotates the primary shaft 138 in a first (e.g., clockwise) direction, the reaction linkage 126 also rotates upward in the first direction and thereby rotates the torque bar 128 in the first direction, such that the torque bar 128 pivots about, and rotates independently from, the primary shaft 138. The clockwise rotation of the torque bar 128 is opposed by the balance spring 132. Conversely, if the float 120 drops, the primary shaft 138 rotates in a second (e.g., counterclockwise) direction and the balance spring 132 forces the torque bar 128 to pivot in the second direction as the reaction linkage 126 rotates downward away from the torque bar 128.

The sensitivity fulcrum 134 is attached to the flapper bar 130 and rests on the upper surface of the torque bar 128. The rocking movement of the torque bar 128 is transferred to the flapper bar 130 through the sensitivity fulcrum 134. Changing the linear position of the sensitivity fulcrum 134 along the length of the flapper bar 130 adjusts the amplitude of the response of the flapper bar 130 to the movement of the torque bar 128. A proximal end of the flapper bar 130 is connected to a flapper bar pivot 142. A distal end of the flapper bar 130 includes a sensor contact 144.

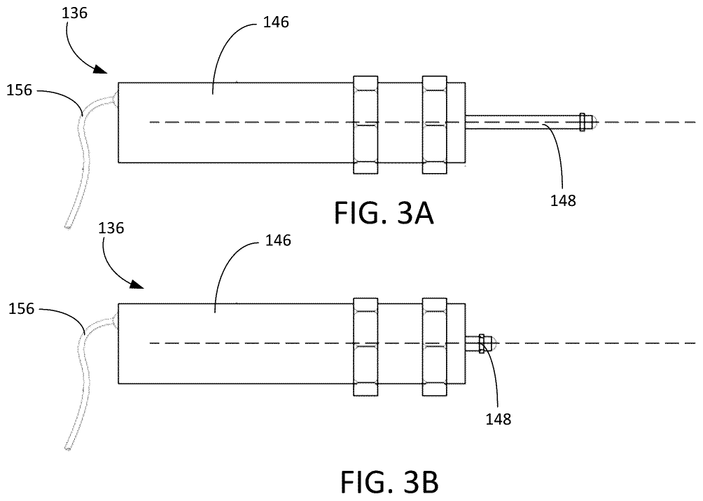

The sensor contact 144 is in contact with the linear position sensor assembly 136. The linear position sensor assembly 136 is depicted in isolation in FIGS. 3A and 3B. The linear position sensor assembly 136 includes a body 146 and a plunger 148 that can be extended (FIG. 3A) or retracted (FIG. 3B) within the body 146. In some embodiments, the plunger 148 is biased toward the extended position by an internal spring, hydraulic pressure, or pneumatic pressure. In other embodiments, the plunger is not biased toward the extended or retracted position and is instead coupled to the sensor contact 144.

The linear position sensor assembly 136 includes internal electrical components that produce an output signal based on the extent to which the plunger 148 is extended or retracted. For example, in the extended position depicted in FIG. 3A, the linear position sensor assembly 136 can be configured to output a 4 milliamp (4 mA) signal. When the plunger 148 is in the retracted position depicted in FIG. 3B, the linear position sensor assembly 136 can be configured to output a 20 milliamp (20 mA) signal. As depicted in FIG. 2, the linear position sensor assembly 136 can be attached to the housing 124 of the level controller 116 with a mounting bracket 150 such that the linear position sensor assembly 136 is located partially inside and partially outside the housing 124. As depicted in FIG. 5, the linear position sensor assembly 136 is connected inside the external housing 137 and the plunger 148 can be connected to the flapper bar 130 through a plunger extension 149. In the embodiment depicted in FIG. 7, the linear position sensor assembly 136 is presented as a self-contained module that is located completely inside the housing 124. Although some embodiments of the linear position sensor assembly 136 are designed for retrofit applications, it will be appreciated that in other embodiments the level controller 116 is specifically constructed to incorporate the linear position sensor assembly 136 and drive mechanism. In each case and as described below, the output signal from the linear position sensor assembly 136 is provided directly or indirectly to the automatic dump valve 118 through a signal cable 156 or a wireless connection.

Thus, as the float 120 rises and falls inside the vessel 100, the level controller 116 produces an electric level output signal representative of the position of the float 120 in the vessel 100. The output of the linear position sensor assembly 136 can be adjusted mechanically by changing the interaction of features inside the level controller 116, or electrically by altering the output from the linear position sensor assembly 136. Importantly, the linear position sensor assembly 136 provides a reliable, adjustable and highly accurate mechanism for detecting small movements of the float 120 and generating an electric signal that can be used as an input for an intelligent control scheme for the automatic dump valve 118.

The dump valve control system 112 further includes a control module 152 and a flow meter 154. The output from the linear position sensor assembly 136 is provided to a control module 152. The control module 152 can be located on the vessel 100, on or in the level controller 116, on the float arm 122, on the automatic dump valve 118, or elsewhere in an operative position to efficiently control the operation of the automatic dump valve 118. The flow meter 154 is configured to measure the volumetric flow rate of petroleum products moving through the oil discharge 110. The flow meter 154 provides a flowrate output signal to the control module 152.

In response to inputs from the linear position sensor assembly 136 and the flow meter 154, the control module 152 is configured to adjust the position of the automatic dump valve 118 within a range of positions from fully open to fully closed to intelligently control the level of the petroleum fluids in the vessel 100. The automatic dump valve 118 can be an electrically or pneumatically actuated valve. If the automatic dump valve 118 is pneumatically actuated, an intervening pneumatic driver is necessary to convert the electrical signals from the control module 152 to a pneumatic signal useable by the automatic dump valve 118.

For example, if the level of the liquid petroleum products in the vessel 100 is within an appropriate range, the float arm 116 may be relatively level or horizontal. If the output from the flow meter 154 also indicates a flow rate within an appropriate range, the control module 152 outputs a responsive signal to maintain the automatic dump valve 118 in its current position.

In contrast, if the level of the liquid petroleum products in the vessel 100 decreases, the linear position sensor assembly 136 produces an electric output signal to the control module 152 based on the movement and position of the plunger 148 within the level controller 116. Based on this input and the flow rate input from the flow meter 154, the control module 152 can output a corrective signal to partially or completely close the automatic dump valve 118. If the level of fluid inside the vessel 100 does not increase at a sufficient rate based on the feed stream 102, the control module 152 can further close the automatic dump valve 118 to further reduce the dump rate through the automatic dump valve 118. Conversely, if the level of the liquid petroleum products in the vessel 100 increases, the control module 152 completely or partially opens the automatic dump valve 118 based on the inputs received from the linear position sensor assembly 136 and the flow meter 154. Again, if the initial dump rate measured by the flow meter 154 is insufficient given the feed stream 102, the control module 152 can further open the automatic dump valve 118 to increase the dump rate to programmed rates or float level-proportional rates to accommodate changing conditions in the vessel 100.

It will be noted that the control module 152 can be configured to adjust the automatic dump valve 118 based on one or both of the output signals generated by the linear position sensor assembly 136 and flow meter 154. If, for example, the linear position sensor assembly 136 outputs a signal indicating that the level of the petroleum liquids in the vessel 100 is acceptable but the flow rate within the flow meter 154 is outside a desired range, the control module 152 can open or close the automatic dump valve 118 to bring the flow rate of the oil discharge 110 into the desired range. If increasing or decreasing the flow rate through the automatic dump valve 118 affects the level of the petroleum products in the vessel 100, the linear position sensor assembly 136 will detect the rotation of the float arm 122 and the control module 152 can send a corrective signal, as necessary, to the automatic dump valve 118. Thus, in exemplary embodiments, the dump valve system 112 is configured to adjust the operation of the automatic dump valve 118 in response to measurements from one or both of the linear position sensor assembly 136 and the flow meter 154.

Although the dump valve system 112 is depicted in use with a three phase separator, the dump valve system 112 can also be used to control the level of fluids in other vessels, including tank batteries, bulk storage tanks, water tanks, and other vessels in which fluid levels must be maintained by controlling the discharge of fluids from the vessel. Accordingly, the term “vessel” as used in this disclosure should be construed to cover any vessel in which the dump valve system 112 can be used to control the level of any liquid products inside the vessel 100.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

It is claimed:

1. A dump valve system for controlling the level of a liquid inside a vessel that includes a liquid discharge, the dump valve system comprising:
an automatic dump valve connected downstream from the liquid discharge and configured to adjust the flow rate of the liquid through the liquid discharge;
a float assembly, wherein the float assembly comprises:
a float inside the vessel; and
a float arm connected to the float;
a level controller, wherein the level controller comprises:
a linear position sensor assembly configured to output an electric signal; and
an internal drive mechanism between the float arm and the linear position sensor assembly, wherein the internal drive mechanism translates a rotational movement of the float arm into a linear movement of the linear position sensor assembly; and
a control module configured to adjust the operation of the automatic dump valve based on the output from the linear position sensor assembly.

2. The dump valve system of claim 1, further comprising a flow meter configured to measure the flow rate of liquids discharged from the automatic dump valve and output a signal representative of the measured flow rate.

3. The dump valve system of claim 2, wherein the control module is also configured to adjust the operation of the automatic dump valve based on the output from the flow meter.

4. The dump valve system of claim 1, wherein the control module is configured to adjust the automatic dump valve to change a dump rate of fluids passing through the automatic dump valve based on the output from the linear position sensor assembly.

5. The dump valve system of claim 1 further comprising a housing attached to the vessel, wherein the float arm extends through the vessel into the housing.

6. The dump valve system of claim 5 further comprising a primary shaft inside the housing, wherein the float arm is directly or indirectly coupled to the primary shaft such that float arm pivots about the primary shaft.

7. The dump valve system of claim 6, wherein the internal drive mechanism comprises:
a reaction linkage connected to and rotatable with the primary shaft;
a torque bar pivotable about the primary shaft;
a flapper bar; and
a sensitivity fulcrum positioned between the flapper bar and the torque bar.

8. The dump valve system of claim 7, wherein the flapper bar comprises:
a flapper bar pivot; and
a sensor contact.

9. The dump valve system of claim 8, wherein the linear position sensor assembly comprises:
a body; and
a plunger in contact with the sensor contact of the flapper bar, wherein the plunger is configured to extend away from and retract into the body in response to movement of the flapper bar.

10. The dump valve system of claim 9, wherein the body of the linear position sensor assembly is completely contained within the housing of the level controller.

11. The dump valve system of claim 9, wherein the body of the linear position sensor assembly is partially contained within the housing of the level controller.

12. A dump valve system for controlling the level of a liquid inside a vessel that includes a liquid discharge, the dump valve system comprising:
an automatic dump valve connected downstream from the liquid discharge and configured to adjust the flow rate of the liquid through the liquid discharge;
a float assembly, wherein the float assembly comprises:
a float inside the vessel; and
a float arm connected to the float;
a level controller, wherein the level controller comprises:
a linear position sensor assembly configured to output an electric signal; and
an internal drive mechanism between the float arm and the linear position sensor assembly, wherein the internal drive mechanism translates a rotational movement of the float arm into a linear movement of the linear position sensor assembly;
a flow meter configured to measure the flow rate of liquids discharged from the automatic dump valve and output a signal representative of the measured flow rate; and
a control module, wherein the control module is configured to adjust the automatic dump valve to change a dump rate of fluids passing through the automatic dump valve based on the output from the linear position sensor assembly and the output from the flow meter.

13. The dump valve system of claim 12 further comprising a primary shaft inside the housing, wherein the float arm is directly or indirectly coupled to the primary shaft such that float arm pivots about the primary shaft.

14. The dump valve system of claim 13, wherein the internal drive mechanism comprises:
a reaction linkage connected to and rotatable with the primary shaft;
a torque bar pivotable about the primary shaft;
a flapper bar; and
a sensitivity fulcrum positioned between the flapper bar and the torque bar.

15. The dump valve system of claim 14, wherein the flapper bar comprises:
a flapper bar pivot; and
a sensor contact.

16. The dump valve system of claim 15, wherein the linear position sensor assembly comprises:
a body; and
a plunger in contact with the sensor contact of the flapper bar, wherein the plunger is configured to extend away from and retract into the body in response to movement of the flapper bar.

17. A dump valve system for controlling the level of a liquid inside a vessel that includes a liquid discharge, the dump valve system comprising:
an automatic dump valve connected downstream from the liquid discharge and configured to adjust the flow rate of the liquid through the liquid discharge;
a float assembly, wherein the float assembly comprises:
a float inside the vessel; and
a float arm connected to the float;
a level controller, wherein the level controller comprises:
a housing;
a primary shaft inside the housing, wherein the float arm is coupled to the primary shaft such that float arm pivots about the primary shaft;
a linear position sensor assembly configured to output an electric signal, wherein the linear position sensor assembly comprises:
a body; and
a plunger that extends from and retracts into the body; and
an internal drive mechanism between the float arm and the linear position sensor assembly, wherein the internal drive mechanism translates a rotational movement of the float arm into a linear movement of the linear position sensor assembly and wherein the internal drive mechanism comprises:
a reaction linkage connected to and rotatable with the primary shaft;
a torque bar pivotable about the primary shaft;
a flapper bar in contact with the plunger of the linear position sensor assembly; and
a sensitivity fulcrum positioned between the flapper bar and the torque bar.

18. The dump valve system of claim 17 further comprising a flow meter configured to measure the flow rate of liquids discharged from the automatic dump valve and output a signal representative of the measured flow rate.

19. The dump valve system of claim 18 further comprising a control module, wherein the control module is configured to adjust the automatic dump valve to change a dump rate of fluids passing through the automatic dump valve based on the output from the linear position sensor assembly and the output from the flow meter.

20. The dump valve system of claim 17, wherein the flapper bar comprises:
a flapper bar pivot; and
a sensor contact, wherein the plunger extends between the body and the sensor contact.
